(19) United States
(12) Patent Application Publication
(10) Pub. No.: US 2024/0021108 A1
(43) Pub. Date: Jan. 18, 2024

(54) INFORMATION TAG FOR MACHINERY

(71) Applicants: Jonathan MACKAY, Redlynch (AU); Alan WATTERS, Alyangula (AU)

(72) Inventors: Jonathan MACKAY, Redlynch (AU); Alan WATTERS, Alyangula (AU)

(21) Appl. No.: 18/350,697

(22) Filed: Jul. 11, 2023

(30) Foreign Application Priority Data
Jul. 12, 2022 (AU) 2022901950

(51) Int. Cl. G09F 3/02

(52) U.S. Cl. CPC G09F 3/02883; G09F 2003/0202; G09F 2003/0208; G09F 2003/0269

(57) ABSTRACT

The information tag includes a generally rectangular body having a top edge, side edges, a lower edge, a first main surface and an opposite second main surface. The body includes a fold line dividing the body into an upper half and a lower half. The body can be folded such that the lower half of the first main surface is adjacent and facing the upper half of the first main surface. The body includes a connector for the lower half to the upper half to maintain the information tag in the folded configuration.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to an information tag for machinery.

### 2. Description of Related Art Including Information Disclosed Under 37 CFR 1.97 and 37 CFR 1.98

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides an information tag comprising a generally rectangular body having a top edge, side edges, a lower edge, a first main surface and an opposite second main surface, the body including a fold line dividing the body into an upper half and a lower half, wherein the body can be folded such that the lower half of the first main surface is adjacent and facing the upper half of the first main surface, and the body includes connection means for connecting the lower half to the upper half to maintain the information tag in the folded configuration.

Preferably, the connection means comprises an extension tab extending from the lower edge and an insertion slot in the upper half, wherein the extension tab is shaped to be received in the insertion slot.

Preferably, the extension tab shaped is shaped as an arrowhead to lock with the insertion slot in use.

Preferably, a connector eyelet is disposed between the slot and the top edge.

Preferably, the first main surface and the second main surface both include writing thereon such as warning notifications or information.

Preferably, the first main surface includes blank information fields which can be filled out by a worker.

Preferably, the first main surface is made from material or coated with material which is compatible with permanent markers such that the information written thereon is permanent and cannot be erased.

Preferably, when the information tag is folded along the fold line, the information field in the first main surface is disposed within the folded information tag.

Preferably, the information tag is made from coated paper with a durable/weather anti-tear design.

Preferably, side edges of the information tag include additional side tabs in the upper half or the lower half, where the side tabs can be folded to cover the exposed side openings of the folded information tag.

Preferably, the connection means comprises a button half in the lower half to connect with a corresponding button half in the upper half.

In another embodiment, the insertion slot is a U-shaped at which the operator has to bend the side arrows of the arrowhead extension tab to insert into the slot, wherein the arrowhead then returns to its original shape and secures the arrowhead extension tab in the slot.

In another embodiment, the tag includes raised ridges around the perimeter of the upper half to avoid the faces of the tag from rubbing.

In another embodiment, the connection means comprises a second eyelet adjacent the lower end of the tag so that the tag can be folded and have a string looped through the first and second eyelets.

In another aspect, the invention provides an information tag comprising a main portion and a tear-off portion at a lower end of the main portion, the main portion comprising a top edge, side edges, a lower edge, a first main surface and an opposite second main surface, the main portion including a fold line dividing the main portion into an upper half and a lower half, wherein the main portion can be folded such that the lower half of the first main surface is adjacent and facing the upper half of the first main surface.

The main portion includes connection means for connecting the lower half to the upper half to maintain the information tag in the folded configuration, the connection means comprising an extension tab extending from the lower edge and an insertion slot in the upper half, wherein the extension tab is shaped as an arrowhead to lock with the insertion slot in use.

The tear-off portion is joined to the main portion via a perforation line therebetween which allows the tear-off portion to be separated from the main portion, wherein the perforation line is shaped such that removal of the tear-off portion exposes the extension tab which is shaped as an arrowhead.

In another embodiment, the line between the arrowhead extension tab and the tear-off portion is a fully cut line, while the line between the lower edge of the main portion and the tear-off portion are perforation lines at either side of the cut line, to allow the tear-off portion to be folded relative to the main portion along the perforation lines which exposes the arrowhead extension tab via the cut line.

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 shows elevation views of the (a) external side and (b) internal side of an information tag according to a preferred embodiment of the present invention in the unfolded configuration thereof.

FIG. 2 shows elevation views of the (a) front view and (b) rear view of the information tag in the folded configuration thereof.

FIG. 3 shows (a) front side perspective view and (b) rear side perspective view of the information tag in the folded configuration thereof.

FIG. 4 shows another internal side view of the information tag in the unfolded configuration with a connector eyelet and connector string.

FIG. 5 shows (a) rear view and (b) front view of the information tag of FIG. 4 in the folded configuration.

FIG. 6 shows (a) front view and (b) rear view an information tag according to another preferred embodiment of the present invention.

FIG. 7 shows a schematic view of another embodiment of a tag which is similar to the first embodiment with additional features.

### DETAILED DESCRIPTION OF THE INVENTION

It should be noted in the following description that like or the same reference numerals in different embodiments denote the same or similar features.

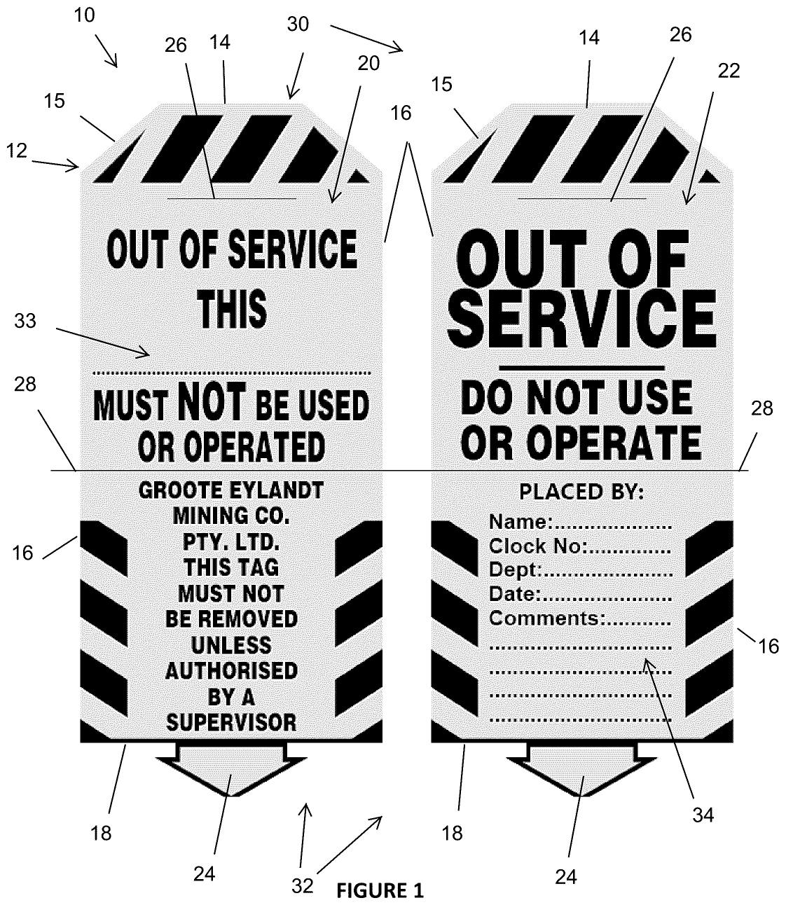

FIG. 1 shows an information tag 10 according to a preferred embodiment of the present invention. The tag 10 comprises a flat generally rectangular body 12 having a top edge 14, side edges 16, a lower edge 18, a first main surface 20 and an opposite second main surface 22. The top edge 14 includes angled end portions 15 to the side edges 16.

The lower edge 18 includes an extension tab 24 which is shaped as an arrowhead. The body 12 also includes an insertion slot 26 formed near a top portion thereof, parallel to the top edge 14 but spaced therefrom. The insertion slot 26 is dimensioned to receive the extension tab 24 therethrough in use and to retain the extension tab 24.

The body 12 further includes a fold line 28 at a mid-portion thereof. The fold line 28 being parallel to the top edge 14 and the edge 18. The fold line 28 divides the body 12 into an upper half 30 and a lower half 32.

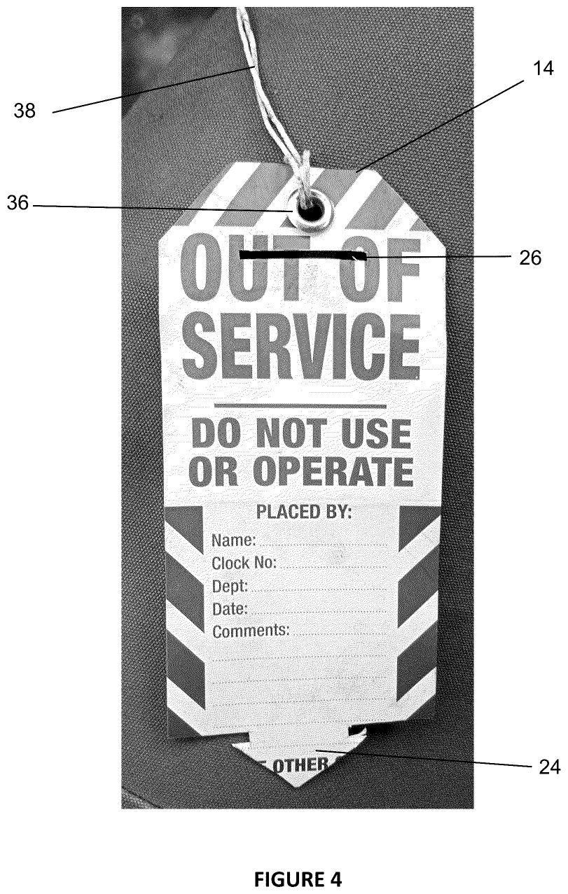

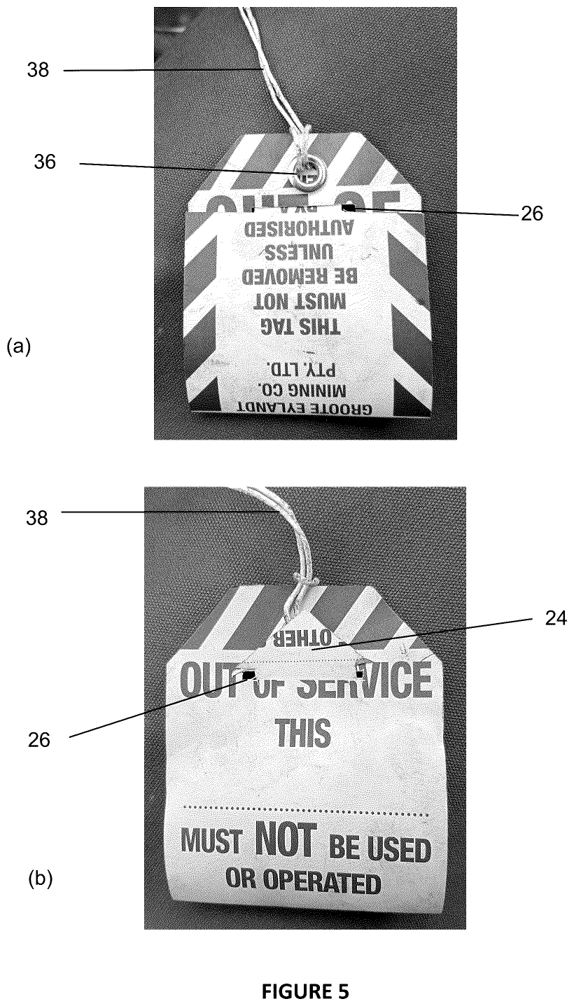

As shown in FIGS. 4 and 5, the body 12 is also provided with a connector eyelet 36 disposed between the slot 26 and the top edge 14. A connector string can then be fed through the eyelet 36 for attaching the information tag 10 to a machine.

The first main surface 20 and the second main surface 22 both include writing thereon such as warning notifications including “OUT OF SERVICE”, “DO NOT USE”, “DO NOT OPERATE” and the like to provide warning and information to workers and possible users about the machinery to which the information tag 10 is attached to. Instead of warning notifications, the first main surface 20 and the second main surface 22 can alternatively include general information on the machinery. The first main surface 20 includes an information field 33 for a worker to write the name/type of the machinery, and the second main surface 22 includes blank information fields 34 which a worker can fill out to provide additional information on the worker who placed the information tag 10, department, date, comments and reasons, etc. The information fields can also be used for general information on the machinery such as date of next service, maintenance date, maintenance person, etc.

The first main surface 20 and the second main surface 22 are preferably made from material or coated with material which is compatible with permanent markers such that the information written on the information fields 33 and 34 are permanent and cannot be erased.

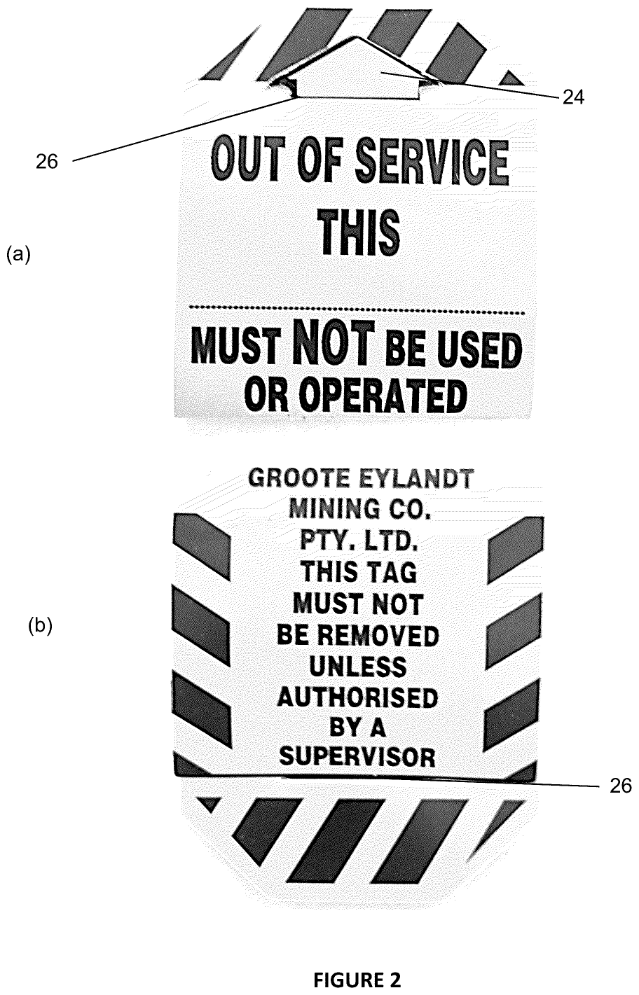

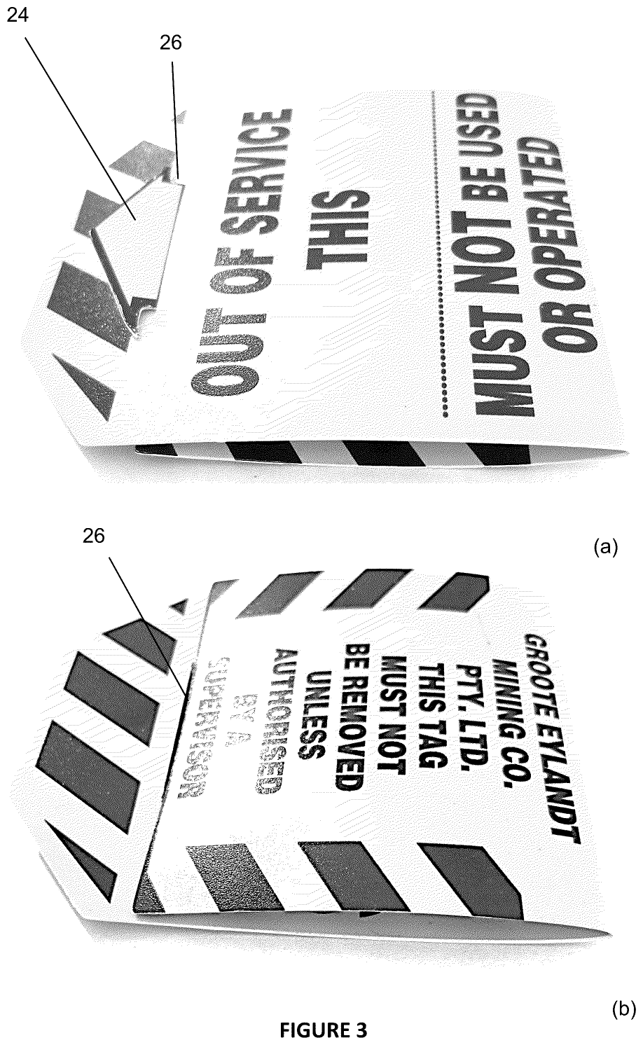

To further protect the information written on the information fields 34, the information tag 10 is folded along the fold line 28 such that the information fields 34 is disposed within the folded information tag 10. The extension tab 24 is inserted into the slot 26 such that the information tag 10 is retained in the folded configuration thereof, as shown in FIGS. 2, 3 and 4. As shown, the folded configuration protects the information fields 34 further from the elements and avoids erasure of the information in the information fields 34.

The first surface 20 in this example is designated as the external surface and the second surface 22 is designated as the internal surface. These designations however can be reversed.

The invention thus provides a foldable out of service/information/isolation tag for machinery or electrical isolations on plant and equipment which stops the writing in the tag from fading, which is a safety issue especially on mine sites.

The information tag 10 will be made from paper, preferably coated paper with a durable/weather anti-tear design. This allows the extension tab 24 to be used repeatedly.

Although a preferred embodiment of the present invention has been described, it will be apparent to skilled persons that modifications can be made to the embodiment shown.

For example, the side edges of the information tag 10 can have additional side tabs in the upper half 30 or the lower half 32, where the side tabs can be folded to cover the exposed side openings of the folded information tag 10.

The extension tab 24 can also be replaced by a button half to connect with corresponding button half in the upper half 30.

The invention is primarily directed for the mining industry for tagging machinery. The invention allows such machinery to be tagged to provide information or warnings to workers regarding the current status of such machinery. Folding of the information tag and locking in the folded configuration provides protection for the information written in the information field 34 which assists with worker safety.

The information tag can also be used in other fields such as construction, road maintenance, building maintenance, etc. where information or warning tags can be used to provide information or warnings to other workers. date of next service, maintenance date,

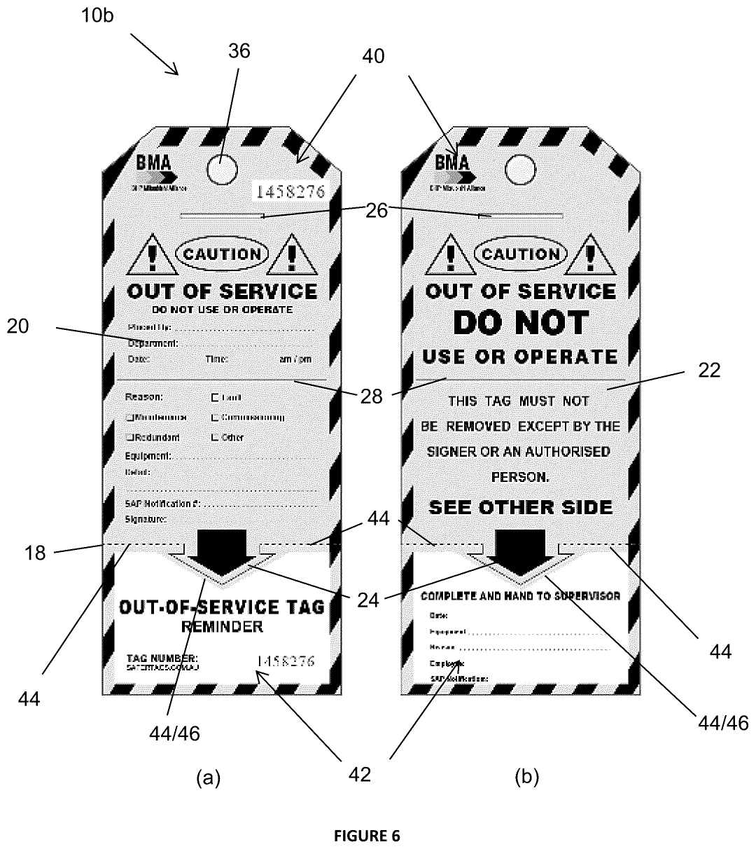

FIG. 6 shows an information tag 10b according to another preferred embodiment of the present invention which comprises a main portion 40 and a tear-off portion 42 at a lower end of the main portion 40. The main portion 40 is a of a similar shape as the tag 10 shown in FIGS. 1 to 5 and similar parts are indicated with similar numerals. The tear-off portion 42 is formed as an extension extending from the lower edge 18 of the main portion 40.

The tear-off portion 42 is initially joined to the main portion 40 via a perforation line 44 therebetween which allows the tear-off portion 42 to be separated from the main portion 40. The perforation line 44 is shaped such that removal of the tear-off portion 42 exposes the extension tab 24 which is shaped as an arrowhead at the lower edge 18 of the main portion 40.

The body 12 similarly also includes an insertion slot 26 formed near a top portion thereof, dimensioned to receive the extension tab 24 therethrough in use and to retain the extension tab 24. The tag 10b similarly comprises a flat generally rectangular body 12, a first main surface 20 and an opposite second main surface 22. The main portion 40 includes the fold line 28 at a mid-portion thereof and a connector eyelet 36,

The first main surface 20 and the second main surface 22 both include writing thereon such as warning notifications and information. The tear-off portion 42 includes identifying information which matches similar identifying information on the main portion 40, such as machine description, serial number, matching QR codes, for example.

In use, the user is able to remove the tear-off portion 42 from the main portion 40 and retain the tear-off portion 42 for office record keeping or similar function. The user is then able to further protect the information written on the information fields of the main portion 40, as the information tag 10 is folded along the fold line 28 such that the information fields are disposed within the folded main portion 40. The extension tab 24 is inserted into the slot 26 such that the information tag 10 is retained in the folded configuration thereof, as shown in FIGS. 2, 3 and 4. The folded configuration protects the information fields 34 further from the elements and avoids erasure of the information in the information fields 34.

In another possible embodiment, the line between the arrowhead extension tab 24 and the tear-off portion 42 is a fully cut line 46, whilst the line between the lower edge 18 of the main portion 40 and the tear-off portion 42 are perforation lines 44 at either side of the cut line 46. This allows the tear-off portion 42 to be folded relative to the main portion 40 along the perforation lines 44 which exposes the arrowhead extension tab 24 via the cut line 46. The user is then able to insert the arrowhead extension tab 24 into the slot 26 while the tear-off portion 42 remains attached to the main portion 40. The tear-off portion 42 can then be removed from the main portion 40 if desired.

The tear-off portion 42 on the bottom can be handed to a supervisor, with a serial number on main tag and the tear off part being identical.

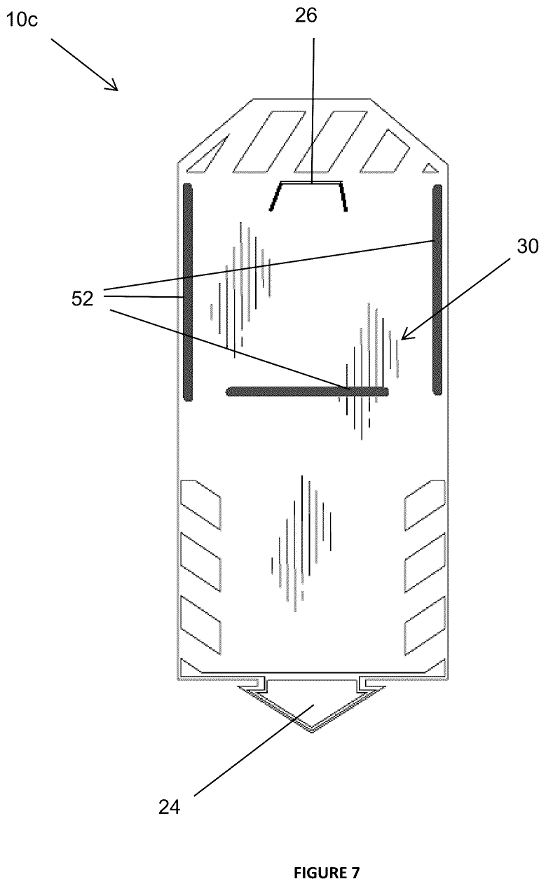

FIG. 7 shows another embodiment of a tag 10c which is similar to the tag with additional features. The tag 10c includes a U-shaped 26 at which the operator has to bend the side arrows of the arrowhead extension tab 24 to insert into the slot 26—the arrowhead 24 then returns to its original flat shape and secures the arrow 24 further and avoid unfolding of the tag 10c.

The tag 10c also includes raised ridges 52 around the perimeter of the upper half 30 to avoid the faces of the tag 10c from rubbing and erasing the writing.

In another possible modification, instead of having the slot 26 and arrow 24, the lower end of the tag can include a second eyelet so that the tag can be folded and have the string looped through both eyelet holes.

The tag can also be made to folding from other directions, like from the sides or diagonally. Different arrow and slot shapes can also be used.

1. An information tag, comprising:
a rectangular body having a top edge, side edges, a lower edge, a first main surface and an opposite second main surface, the body including a fold line dividing the body into an upper half and a lower half,
wherein the body can be folded such that the lower half of the first main surface is adjacent and facing the upper half of the first main surface; and
connection means for the lower half to the upper half to maintain the information tag in the folded configuration.

2. The information tag of claim 1, wherein the connection means comprises an extension tab extending from the lower edge and an insertion slot in the upper half, wherein the extension tab is shaped to be received in the insertion slot.

3. The information tag of claim 2, wherein the extension tab is shaped as an arrowhead to lock with the insertion slot in use.

4. The information tag of claim 2, further comprising: a connector eyelet is disposed between the slot and the top edge.

5. The information tag of claim 1, wherein the first main surface and the second main surface both include writing thereon such as warning notifications or information.

6. The information tag of claim 1, wherein the first main surface and the second main surface both include blank information fields which can be filled out by a worker.

7. The information tag of claim 1, wherein the first main surface is comprised of material or coated with material which is compatible with permanent markers.

8. The information tag of claim 6, wherein when the information tag is folded along the fold line, the information field in the first main surface is disposed within the folded information tag.

9. The information tag of claim 1, wherein the body is comprised of coated paper with a durable/weather anti-tear design.

10. The information tag of claim 1, wherein side edges of the information tag include additional side tabs in the upper half or the lower half, and wherein the side tabs can be folded to cover the exposed side openings of the folded information tag.

11. The information tag of claim 1, wherein the connection means comprises a button half in the lower half to connect with a corresponding button half in the upper half.

12. The information tag of claim 3, wherein the insertion slot has a U-shape at which the operator has to bend the side arrows of the arrowhead extension tab to insert into the slot, and wherein the arrowhead then returns to its original shape and secures the arrowhead extension tab in the slot.

13. The information tag of claim 1, wherein the tag includes raised ridges around the perimeter of the upper half to avoid the faces of the tag from rubbing.

14. The information tag of claim 4, wherein the connection means comprises a second eyelet adjacent the lower end of the tag so that the tag can be folded and have a string looped through the first and second eyelets.

15. An information tag, comprising:
a main portion; and
a tear-off portion at a lower end of the main portion,
wherein the main portion comprises a top edge, side edges, a lower edge, a first main surface and an opposite second main surface, the main portion including a fold line dividing the main portion into an upper half and a lower half,
wherein the main portion can be folded such that the lower half of the first main surface is adjacent and facing the upper half of the first main surface,
wherein the main portion further comprises connection means for the lower half to the upper half to maintain the information tag in the folded configuration, the connection means comprising an extension tab extending from the lower edge and an insertion slot in the upper half, wherein the extension tab is shaped as an arrowhead to lock with the insertion slot in use,
wherein the tear-off portion is joined to the main portion via a perforation line therebetween which allows the tear-off portion to be separated from the main portion, wherein the perforation line is shaped such that removal of the tear-off portion exposes the extension tab which is shaped as an arrowhead.

16. The information tag of claim 15, wherein the line between the arrowhead extension tab and the tear-off portion is a fully cut line, while the line between the lower edge of the main portion and the tear-off portion are perforation lines at either side of the cut line, to allow the tear-off portion to be folded relative to the main portion along the perforation lines which exposes the arrowhead extension tab via the cut line.
